(19) United States
(12) Patent Application Publication
(10) Pub. No.: US 2013/0166428 A1
(43) Pub. Date: Jun. 27, 2013

(54) APPARATUS AND METHOD FOR PERFORMING TIME SYNCHRONIZATION BASED AUTOMATED POWER TRADING FOR REAL TIME PRICING SYSTEM

(71) Applicants: Tae In HWANG, Daejeon (KR); Il Woo Lee, Daejeon (KR)

(72) Inventors: Tae In HWANG, Daejeon (KR); Il Woo Lee, Daejeon (KR)

(73) Assignee: Electronics and Telecommunications Research Institute, Daejeon (KR)

(21) Appl. No.: 13/609,842

(22) Filed: Sep. 11, 2012

(30) Foreign Application Priority Data
Dec. 27, 2011 (KR) 10-2011-0143492

(51) Int. Cl. G06Q 40/04

(52) U.S. Cl. 705/37

(57) ABSTRACT

Provided is an apparatus and method for performing time synchronization based automated power trading for a real time pricing system. The power trading apparatus may include a time synchronizing unit to synchronize at least one of a power market server, a smart meter, and a time information to provide the power market server with time, a power purchasing and selling price monitoring unit to receive power purchasing and selling price information from the power market server to monitor power purchasing and selling prices that change in real time and to compare the power purchasing and selling prices to predetermined reference prices for power trading, and an inverter and power storage apparatus controller to controlling power conversion of an inverter, and charging and discharging of a power storage apparatus to purchase and sell power at the reference prices.

### CROSS-REFERENCE TO RELATED APPLICATION

This application claims the priority benefit of Korean Patent Application No. 10-20 11-0143492, filed on Dec. 27, 2011, in the Korean Intellectual Property Office, the disclosure of which is incorporated herein by reference.

### BACKGROUND

1. Field of the Invention

Exemplary embodiments of the present invention relate to an apparatus and method for performing time synchronization based automated power trading for a real time pricing system in which power trading is automatically performed based on time synchronization in a smart grid based real time pricing environment.

2. Description of the Related Art A conventional power grid is a unidirectional structure through which power is supplied from a small number of utility providers, and users passively receive power as simple consumers. However, as an importance of conserving new renewable energy increases, various power storage apparatuses including batteries of personal vehicles are becoming highly advanced, and the power storage apparatuses are being linked to the conventional power grid, interest in a bidirectional power grid is increasing. In the aforementioned environment, in order to have users actively participate in efficient use of power, efforts are being made to apply real time pricing to an amount of power usage. However, it is not easy to calculate an amount of electricity for the users who consume or sell power at an arbitrary time with prices that change in real time. In addition, it is inconvenient and difficult for the users to purchase or sell power at desired prices while continuously monitoring frequent changes to real time usage.

Therefore, there is a need for a method of purchasing and selling power using prices that change in real time.

### SUMMARY

An aspect of the present invention provides an apparatus and for performing time synchronization based automated power trading for a real time pricing system capable of purchasing and selling power using prices that change in real time.

According to an aspect of the present invention, there is provided a power trading apparatus. The power trading apparatus may include a time synchronizing unit to synchronize at least one of a power market server, a smart meter, and a time information providing server with time, a power purchasing and selling price monitoring unit to receive power purchasing and selling price information from the power market server to monitor power purchasing and selling prices that change in real time based on the received power purchasing and selling price information, and to compare the power purchasing and selling prices to predetermined reference prices for power trading, and an inverter and power storage apparatus controller to control power conversion of an inverter and charge and discharge of a power storage apparatus in order to purchase and sell power at the reference prices when the power purchasing and selling prices reach the reference prices.

The time synchronizing unit may receive time information from at least one of the power market server, the smart meter, and the time information providing server to synchronize time.

The time synchronizing unit may receive the time information from the smart meter in which time is synchronized based on the time information received from the power market server to synchronize time.

The power trading apparatus may further include a power trading price setting unit for setting power purchasing and selling prices input by users as the reference prices for power trading.

The power trading apparatus may further include an accounting information outputting unit to output accounting information about power purchasing and selling based on power charge information generated by purchasing power at the predetermined reference prices and incentive information obtained by selling power.

According to another aspect of the present invention, there is provided a power trading system. The power trading system may include a power storage apparatus to store power, a smart meter to measure an amount of power input to and output from the power storage apparatus through a power grid to inform an accounting server of the measured amount of power, a grid linked inverter to convert power input and output from the power storage apparatus while being interlocked with the power grid, a control point to receive power purchasing and selling prices from users to provide accounting information about power purchasing and selling to the users, and a power trading apparatus to synchronize time of at least one of the power market server, the smart meter, and the time information providing server, to receive power purchasing and selling price information from the power market server to monitor power purchasing and selling prices that change in real time based on the received power purchasing and selling price information, to compare the power purchasing and selling prices to predetermined reference prices for power trading, and to control the inverter and the power storage apparatus when the power purchasing and selling prices match the reference prices to trade power at the predetermined reference prices.

According to still another aspect of the present invention, there is provided a method of trading power using a power trading apparatus. The method may include synchronizing, the power trading apparatus, at least one of a power market server, a smart meter, and a time information providing server with time, receiving power purchasing and selling price information from the power market server to monitor power purchasing and selling prices that change in real time based on the received power purchasing and selling price information, comparing the power purchasing and selling prices to predetermined reference prices for power trading, and controlling power conversion of an inverter, and charging and discharging of a power storage apparatus in order to purchase and sell power at the reference prices when the power purchasing and selling prices match the predetermined reference prices.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a time synchronization based automated power trading apparatus for real time pricing according to an embodiment of the present invention;

FIG. 2 is a flowchart illustrating a time synchronization based automated power trading method for real time pricing according to an embodiment of the present invention;

FIG. 3 is a block diagram illustrating a time synchronization based on an automated power trading system for real time pricing according to another embodiment of the present invention; and

FIG. 4 is a timing diagram illustrating a time synchronization based automated power trading method for real time pricing according to the embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, the embodiments of the present invention will be described in detail with reference to the accompanying drawing.

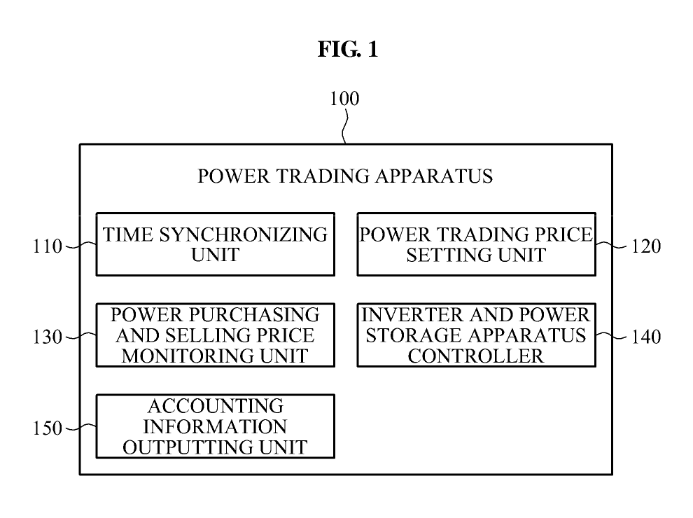

FIG. 1 is a block diagram illustrating a time synchronization based automated power trading apparatus for real time pricing according to an embodiment of the present invention.

A power trading apparatus 100 according to the present invention calculates power usage and sales charges of users with power prices that change in real time based on time synchronization in a conventional smart grid environment and automatically purchases and sells power in accordance with power trading prices set by the users. The power trading apparatus 100 may include a time synchronizing unit 110, a power trading price setting unit 120, a power purchasing and selling price monitoring unit 130, an inverter and power storage apparatus controller 140, and an accounting information outputting unit 150.

The time synchronizing unit 110 synchronizes at least one of a power market server and a smart meter and authorized time information providing server with time so that the users may purchase or sell power at desired prices among power prices that change in real time.

For example, the time synchronizing unit 110 may receive authorized time information from at least one of the power market server and the smart meter, and time information providing server to have time information of the power trading apparatus 100 match the received time information.

A smart grid based smart meter may include a function of receiving time information from the power market server to have time information of a power trading market match time information thereof. Therefore, the time synchronizing unit 110 according to the present invention may request the smart meter to provide time information without requesting the power market server or the time information providing server to provide time information to receive time information and to synchronize time.

The power trading price setting unit 120 sets power purchasing and selling prices input by the users as reference prices for power trading.

The power purchasing and selling price monitoring unit 130 receives power purchasing and selling price information from the power market server or a utility service provider system, monitors power purchasing and selling prices that change in real time based on the received power purchasing and selling price information, and compares the received power purchasing and selling prices to the reference prices for power trading that are set by the power trading price setting unit 120 to analyze the comparison result.

The inverter and power storage apparatus controller 140 controls power conversion of an inverter as well as charging and discharging of the power storage apparatus in order to purchase and sell power at the set reference prices when the power purchasing and selling prices received by the power purchasing and selling price monitoring unit 130 match the reference prices set by the users.

The accounting information outputting unit 150 outputs accounting information about power purchases and sales based on power charge information generated by purchasing power at the reference prices when the users request to purchase power or in real time and incentive information obtained by selling power. For example, the accounting information outputting unit 150 may provide the power charge information and the incentive information that are received from an accounting server directly to the users or may process the power charge information and the incentive information to provide accounting information including the power charge information and the incentive information to the users.

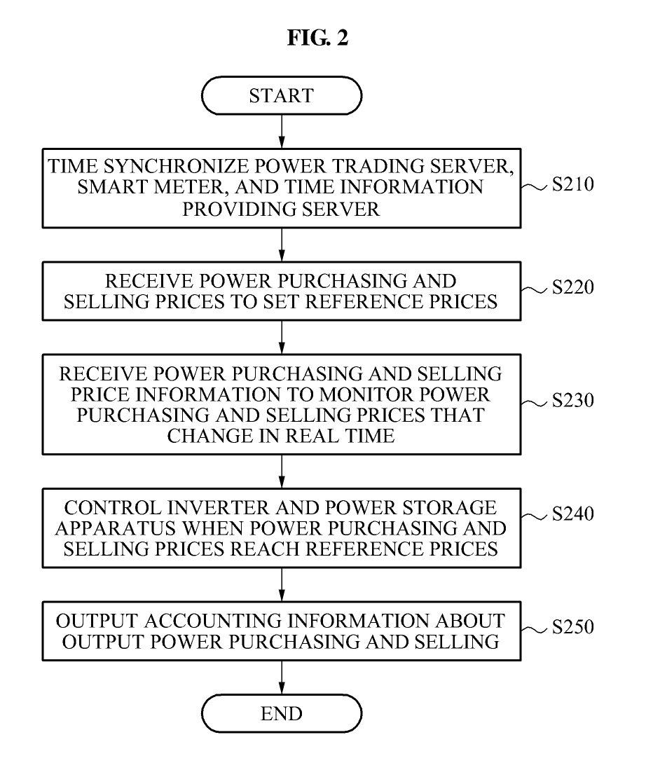

FIG. 2 is a flowchart illustrating a time synchronization based automated power trading method for real time pricing according to an embodiment of the present invention. Hereinafter, a method of trading power using the power trading apparatus will be described with reference to FIG. 2.

First, the power trading apparatus synchronizes at least one of the power market server and the smart meter, and time information providing server with time in order to purchase or sell power at the prices set by the users in real time pricing in operation S210.

Here, the power trading apparatus may receive time information from at least one of the power market server and the smart meter and time information providing server to synchronize time based on the time information. However, the power trading apparatus may receive time information from the time synchronized smart meter based on the time information received from the power market server to synchronize time without requesting the power market server or the time information providing server to provide time information.

The power trading apparatus receives power purchasing and selling prices by the users to set the received power purchasing and selling prices as the reference prices for power trading in operation S220. The power trading apparatus receives power purchasing and selling price information from the power market server to monitor power purchasing and selling prices that change in real time based on the power purchasing and selling price information in operation S230 and compares the power purchasing and selling prices to the predetermined reference prices for power trading. When the power purchasing and selling prices reach the reference prices, the power trading apparatus controls power conversion of the inverter and charge and discharge of the power storage apparatus in order to purchase and sell power at the reference prices in operation S240.

The power trading apparatus outputs accounting information about power purchases and sales based on power charge information generated by purchasing power at the predetermined reference prices and incentive information obtained by selling power in operation S250 so that the users may check the content of power purchased and sold by the users.

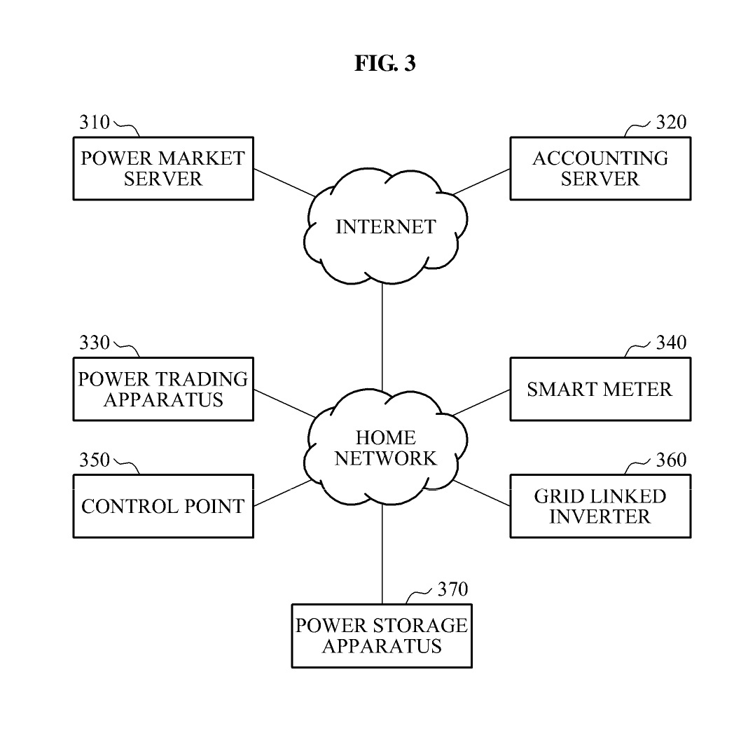

FIG. 3 is a block diagram illustrating a time synchronization based on an automated power trading system for real time pricing according to another embodiment of the present invention. Hereinafter, the power trading system according to the present invention will be described with reference to FIG. 3.

The power trading system according to the present invention is connected to a power market server 310 for providing power purchasing and selling price information via the Internet, in real time, and an accounting server 320 for providing real time power charges of users and incentive information through power sales.

Referring to FIG. 3, the power trading system includes a power trading apparatus 330, a smart meter 340, a control point 350, a grid linked inverter 360, and a power storage apparatus 370 that may be connected to each other through a home network.

The power trading apparatus 330 time synchronizes at least one of the power market server 310, the smart meter 340, and the time information providing server, receives the power purchasing and selling price information from the power market server 310 to monitor the power purchasing and selling prices that change in real time based on the received power purchasing and selling price information, compares the received power purchasing and selling prices to predetermined reference prices for power trading, and controls the grid linked inverter 360 and the power storage apparatus 370 when the power purchasing and selling prices reach the reference prices to purchase power at purchasing prices set by the users, to store the purchased power in the power storage apparatus 370, to sell the power stored in the power storage apparatus 370 at the purchasing prices set by the users through a power grid, and to check charges or incentives generated in relation to the preceding. Here, the power trading apparatus 330 may receive time information from at least one of the power market server 310, the smart meter 340, and the time information providing server for time synchronization.

The power trading apparatus 330 receives accounting information including the power charge information generated by purchasing power at the reference prices and the incentive information obtained by selling power from the accounting server 320 and transmits the received accounting information to the control point 350 so that the accounting information about power purchasing and selling may be provided to the users.

The smart meter 340 measures an amount of power input to and output from the power storage apparatus through the power grid to inform the accounting server of the measured amount of power. In addition, the smart meter 340 receives time information from the power market server 310 and transmits the received time information to the power trading apparatus 330 so that the time of the power trading apparatus 330 may be time synchronized with the power market server 310.

The control point 350 receives power purchasing and selling prices from the users and provides the accounting information about power purchasing and selling to the users. The control point 350 transmits the power purchasing and selling prices received from the users to the power trading apparatus 330 so that the power trading apparatus 330 may set the power purchasing and selling prices received from the users as reference prices. Therefore, the control point 350 may provide a graphic interface through which the users may set power trading prices and check real time accounting information.

The grid linked inverter 360 converts power input to and output from the power storage apparatus 370 in accordance with request of the power trading apparatus 330 while being interlocked with the power grid.

The power storage apparatus 370 stores power input through the power grid or discharges the stored power to the power grid in accordance with the request of the power trading apparatus 330.

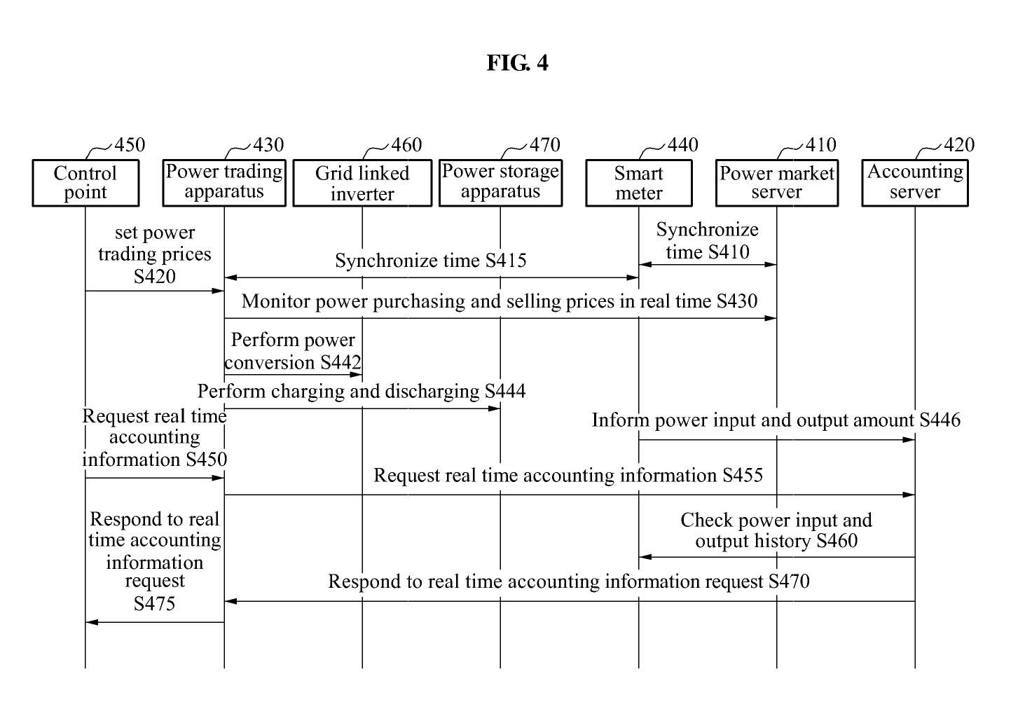

FIG. 4 is a timing diagram illustrating a time synchronization based automated power trading method for real time pricing according to the embodiment of the present invention.

In the conventional smart grid environment, in order to calculate the power using and selling charges of the users with the power prices that change reflected in real time based on time synchronization and to automatically purchase and sell power in accordance with the power trading prices set by the users, first, a smart meter 440 synchronizes a power market server 410 with time information in operation S410. A power trading apparatus 430 receives time information from the smart meter 440 whose time is synchronized with the power market server or the power market server 410 to have the time information coincide in operation S415.

When the users set the power trading prices in the power trading apparatus 430 through a control point 450 in operation S420, the power trading apparatus 430 receives power purchasing and selling price information from the power market server 410 to monitor power purchasing and selling prices in real time in operation S430, controls power conversion of a grid linked inverter 460 when the power purchasing and selling prices reach reference prices set by the users in operation S442, and controls charge and discharge of a power storage apparatus 470 in operation S444. The smart meter 440 informs an accounting server 420 of a changing amount of input and output power in operation S446.

When the users request accounting information through the control point 450 in operation S450 the power trading apparatus 430 requests the accounting server 420 to verify the accounting information in operation S455. Subsequently, the accounting server 420 verifies and analyzes power input and output amount history information from the smart meter 440 in order to analyze user accounting information in operation S460 and transmits the analyzed information to the power trading apparatus 430 in operation S470. Then, the power trading apparatus 430 transmits the transmitted information to the control point 450 in operation S475 so that the accounting information is output.

In the smart grid based real time pricing environment, the real time prices of power purchased or sold by the users are calculated correctly through time synchronization and power is automatically purchased and sold in accordance with power trading prices set by the users so that the users may conveniently perform power trading and that it is possible to have the users actively participate in efficient use of power.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A power trading apparatus, comprising:
a time synchronizing unit to synchronize at least one of a power market server, a smart meter, and a time information providing server with time;
a power purchasing and selling price monitoring unit to receive power purchasing and selling price information from the power market server to monitor power purchasing and selling prices that change in real time based on the received power purchasing and selling price information and for comparing the power purchasing and selling prices to predetermined reference prices for power trading; and
an inverter and power storage apparatus controller to control power conversion of an inverter and charge and discharge of a power storage apparatus in order to purchase and sell power at the predetermined reference prices when the power purchasing and selling prices match the predetermined reference prices.

2. The power trading apparatus of claim 1, wherein the time synchronizing unit receives time information from at least one of the power market server, the smart meter, and the time information providing server to synchronize time.

3. The power trading apparatus of claim 1, wherein the time synchronizing unit receives the time information from the smart meter in which time is synchronized based on the time information received from the power market server to synchronize time.

4. The power trading apparatus of claim 1, further comprising:
a power trading price setting unit for setting power purchasing and selling prices input by users as reference prices for power trading.

5. The power trading apparatus of claim 1, further comprising:
an accounting information outputting unit to output accounting information about power purchasing and selling based on power charge information generated by purchasing power at the predetermined reference prices and incentive information obtained by selling power.

6. A power trading system, comprising:
a power storage apparatus to store power;
a smart meter to measure an amount of power input to and output from the power storage apparatus through a power grid to inform an accounting server of the measured amount of power;
a grid linked inverter to convert power input and output from the power storage apparatus while being interlocked with the power grid;
a control point to receive power purchasing and selling prices from users to provide accounting information about power purchasing and selling to the users; and
a power trading apparatus to synchronize at least one of the power market server, the smart meter, and the time information providing server with time, for receiving power purchasing and selling price information from the power market server to monitor power purchasing and selling prices that change in real time based on the received power purchasing and selling price information, to compare the power purchasing and selling prices to predetermined reference prices for power trading, and to control the inverter and the power storage apparatus when the power purchasing and selling prices match the predetermined reference prices at which power is to be traded.

7. The power trading system of claim 6, wherein the power trading apparatus receives time information from at least one of the power market server, the smart meter, and the time information providing server to synchronize time.

8. The power trading system of claim 6, wherein the smart meter receives time information from the power market server and transmits the received time information to the power trading apparatus to synchronize times of the power trading apparatus and the power market server.

9. The power trading system of claim 6, wherein the control point transmits the received power purchasing and selling prices to the power trading apparatus so that the power trading apparatus sets the power purchasing and selling prices as reference prices.

10. The power trading system of claim 6, wherein the power trading apparatus receives accounting information including power charge information generated by purchasing power at the reference prices from the accounting server and incentive information obtained by selling power, and transmits the received accounting information to the control point to provide the accounting information about power purchasing and selling the users.

11. A method of trading power using a power trading apparatus, comprising:
synchronizing, by the power trading apparatus, time of at least one of a power market server, a smart meter, and a time information providing server;
receiving power purchasing and selling price information from the power market server to monitor power purchasing and selling prices that change in real time based on the received power purchasing and selling price information;
comparing the power purchasing and selling prices to predetermined reference prices for power trading; and
controlling power conversion of an inverter and charging and discharging of a power storage apparatus in order to purchase and sell power at the predetermined reference prices when the power purchasing and selling prices match the reference prices.

12. The method of claim 11, wherein, in the synchronizing of the time, time information is received from at least one of the power market server, the smart meter, and the time information providing server to synchronize time based on the time information.

13. The method of claim 11, wherein, in the synchronizing of the time, the time information is received from a smart meter in which time is synchronized based on time information received from the power market server to synchronize time.

14. The method of claim 11, further comprising:
receiving power purchasing and selling prices to set the received power purchasing and selling prices as reference prices for power trading.

15. The method of claim 11, further comprising:
outputting accounting information about power purchasing and selling based on power charge information generated by purchasing power at the predetermined reference prices and incentive information obtained by selling power.
